(19) United States
(12) Patent Application Publication
(10) Pub. No.: US 2026/0253994 A1
(43) Pub. Date: Aug. 27, 2026

(54) POWER STORAGE DEVICE

(71) Applicants: TOYOTA JIDOSHA KABUSHIKI KAISHA, Toyota-shi (JP); Prime Planet Energy & Solutions, Inc., Tokyo (JP)

(72) Inventors: Masato ONO, Nagoya-shi (JP); Norihiro OSE, Nagoya-shi (JP); Yasuhiro SAKASHITA, Nisshin-shi (JP); Koichi YANASE, Nagoya-shi (JP); Takeru HARA, Toyota-shi (JP); Yuka YOKOI, Nagoya-shi (JP); Kohji UMEMURA, Okazaki-shi (JP); Toshiki IMABORI, Kasai-shi (JP); Yoshinori HIRANO, Nagoya-shi (JP); Satoshi FUJIMURA, Toki-shi (JP)

(73) Assignees: TOYOTA JIDOSHA KABUSHIKI KAISHA, Toyota-shi (JP); Prime Planet Energy & Solutions, Inc., Tokyo (JP)

(21) Appl. No.: 19/448,564

(22) Filed: Jan. 14, 2026

(30) Foreign Application Priority Data
Feb. 27, 2025 (JP) 2025-029888

(51) Int. Cl. H01M 10/6568; B60L 50/64; H01M 10/04; H01M 10/613; H01M 10/625; H01M 10/647; H01M 10/6555; H01M 50/209

(52) U.S. Cl. CPC H01M 10/6568; B60L 50/64; H01M 10/0431; H01M 10/613; H01M 10/625; H01M 10/647; H01M 10/6555; H01M 50/209; H01M 2220/20

(57) ABSTRACT

A power storage device includes a first power storage cell, a second power storage cell, and an adhesive material. A first recessed portion is created on a side face of a cell case of the first power storage cell, recessed from a principal surface toward a gap between first arcuate portions. A second recessed portion is created on a side face of a cell case of the second power storage cell, recessed from a principal surface toward a gap between second arcuate portions. The adhesive material fills in each of the first recessed portion and the second recessed portion.

### CROSS-REFERENCE TO RELATED APPLICATION

This application claims priority to Japanese Patent Application No. 2025-029888 filed on February 27, 2025. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Japanese Unexamined Patent Application Publication No. 2021-089812 (JP 2021-089812 A) discloses a battery module in which a plurality of secondary batteries is disposed side by side.

### SUMMARY

In the battery module described in JP 2021-089812 A, when the secondary batteries (power storage cells) expand (contract) due to charging and discharging, misalignment will conceivably occur among the secondary batteries.

The present disclosure has been made to solve the foregoing problem, and an object thereof is to provide a power storage device that can suppress misalignment from occurring between power storage cells disposed side by side.

A power storage device according to an aspect of the present disclosure includes a first power storage cell including a plurality of first wound electrode assemblies disposed side by side in a first direction, and a first housing case that houses the first wound electrode assemblies, a second power storage cell including a plurality of second wound electrode assemblies disposed side by side in the first direction, and a second housing case that houses the second wound electrode assemblies, and an adhesive material disposed between the first housing case and the second housing case. Each of the first wound electrode assemblies is wound so as to surround a periphery of a first winding axis that extends in an axial direction intersecting the first direction. Each of the second wound electrode assemblies is wound so as to surround a periphery of a second winding axis that extends in the axial direction. The second power storage cell is disposed at a position adjacent to the first power storage cell in a second direction intersecting each of the first direction and the axial direction. The first housing case includes a first side face disposed on the second housing case side in the second direction. The second housing case includes a second side face disposed on the first housing case side in the second direction. Each of the first wound electrode assemblies is disposed at a position facing the first side face, and includes a first arcuate portion with an arcuate shape as viewed from a position away from the first power storage cell in the axial direction. Each of the second wound electrode assemblies is disposed at a position facing the second side face, and includes a second arcuate portion with an arcuate shape as viewed from a position away from the second power storage cell in the axial direction. The first side face includes a first principal surface, and also, a first recessed portion that is recessed from the first principal surface toward a first gap between the first arcuate portions aligned in the first direction is created in the first side face. The second side face includes a second principal surface, and also, a second recessed portion that is recessed from the second principal surface toward a second gap between the second arcuate portions aligned in the first direction is created in the second side face. The adhesive material fills in each of the first recessed portion and the second recessed portion.

According to the present disclosure, misalignment between power storage cells disposed side by side can be suppressed from occurring.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view illustrating a configuration of a power storage device according to a first embodiment;

FIG. 2 is a plan view illustrating the configuration of the power storage device according to the first embodiment;

FIG. 3 is an exploded perspective view illustrating a configuration of a power storage cell according to the first embodiment;

FIG. 4 is a cross-sectional view illustrating the configuration of the power storage cell according to the first embodiment;

FIG. 5 is a plan view illustrating a configuration of a power storage device according to a second embodiment;

FIG. 6 is a cross-sectional view illustrating the configuration of the power storage cell according to the second embodiment; and

FIG. 7 is a cross-sectional view taken along line VII-VII in FIG. 5.

### DETAILED DESCRIPTION OF EMBODIMENTS

Embodiments of the present disclosure will be described with reference to the drawings. Note that in the drawings referred to below, members that are the same or are equivalent to being the same are denoted by the same numbers.

### First Embodiment

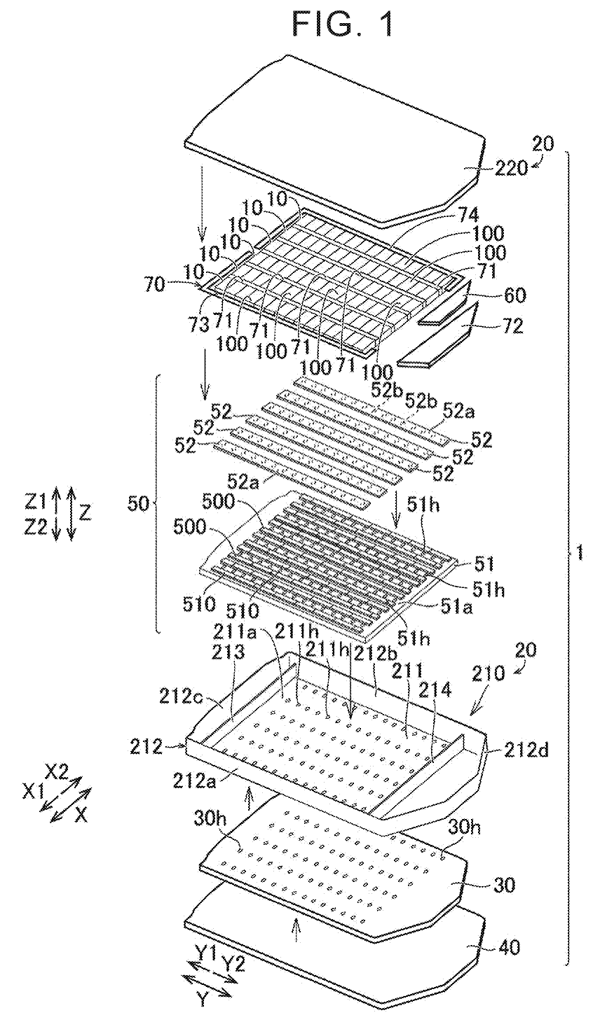

FIG. 1 is an exploded perspective view illustrating a configuration of a power storage device 1 according to a first embodiment of the present disclosure. The power storage device 1 is installed in a vehicle (omitted from illustration), for example. Examples of the vehicle include a hybrid electric vehicle, a plug-in hybrid electric vehicle, and a battery electric vehicle. Note that the power storage device 1 may be provided in electrical equipment other than the vehicle (e.g., a stationary power storage device).

Note that in the present specification, an X direction, a Y direction, and a Z direction are directions that are perpendicular to each other. For example, the X direction and the Y direction may correspond to a front-rear direction and a right-left direction, respectively, when the power storage device 1 is installed in the vehicle. Also, the Z direction may be an up-down direction. Specifically, a Z1 direction and a Z2 direction may be upward and downward, respectively. Note that the X direction and the Y direction are examples of "second direction" and "first direction", respectively, in the present disclosure. Also, the Z direction is an example of "axial direction" in the present disclosure.

The power storage device 1 includes a plurality of power storage stacks 10, a housing case 20, an insulating plate 30, a panel member 40, a wiring panel 50, equipment 60, and a cooling device 70. Each of the power storage stacks 10 is formed in a shape of a rectangular cuboid that is long in the Y direction. The power storage stacks 10 are arrayed in the X direction. Each of the power storage stacks 10 includes a plurality of power storage cells 100 arrayed in the Y direction.

The housing case 20 houses the power storage stacks 10, the wiring panel 50, the equipment 60, and the cooling device 70. The housing case 20 includes a lower case 210 and an upper cover 220. The upper cover 220 is disposed upward (Z1 side) from the lower case 210.

The lower case 210 is formed opening upward. The lower case 210 is formed from a metal such as, for example, aluminum or the like. The lower case 210 includes a bottom plate 211, a peripheral wall 212, a partition wall 213, and a partition wall 214.

The bottom plate 211 is in a form of a plate. The bottom plate 211 has a plurality of through holes 211h formed at intervals in the X direction and the Y direction.

The peripheral wall 212 is erected upright from an outer peripheral edge portion of the bottom plate 211. The peripheral wall 212 has a form surrounding the power storage stacks 10.

An end plate 212c and an end plate 212d are disposed apart in the Y direction. The end plate 212c and the end plate 212d are formed extending in the X direction. The end plate 212c connects one end of a side wall 212a to one end of a side wall 212b. The end plate 212d connects the other end of the side wall 212a to the other end of the side wall 212b.

The partition walls 213 and 214 are disposed within a region surrounded by the bottom plate 211 and the peripheral wall 212. The partition wall 213 is disposed adjacent to the end plate 212c. The partition wall 214 is disposed at a distance from the end plate 212d in the Y direction. Each of the partition wall 213 and the partition wall 214 is formed extending in the X direction. The partition wall 213 and the partition wall 214 have a function of constraining each of the power storage stacks 10 from both sides thereof in the Y direction.

A space formed by the lower case 210 and the upper cover 220 houses the power storage stacks 10, the wiring panel 50, the equipment 60, and the cooling device 70.

The insulating plate 30 is made of an electrically insulating material (e.g., resin composition). The insulating plate 30 is formed in a plate form, for example. The insulating plate 30 has a plurality of through holes 30h formed at intervals in the X direction and the Y direction. The insulating plate 30 is disposed between the panel member 40 and the bottom plate 211 of the lower case 210. The insulating plate 30 is fixed to a lower face of the bottom plate 211.

The panel member 40 has a function of protecting the bottom plate 211 of the lower case 210. The panel member 40 is formed so as to cover the insulating plate 30 and the lower face of the bottom plate 211. The panel member 40 is formed in a plate form, for example.

The wiring panel 50 is disposed downward from the power storage stacks 10. The wiring panel 50 includes an insulating plate 51, a plurality of bus bar modules 500, and a plurality of insulating protectors 52.

The insulating plate 51 is made of an electrically insulating material (e.g., resin composition). As an example, the insulating plate 51 is made of a flexible resin. The insulating plate 51 is formed in a plate form, for example. The insulating plate 51 is disposed on a portion of an upper face 211a of the bottom plate 211 of the lower case 210 that is situated between the partition wall 213 and the partition wall 214.

The insulating plate 51 has a plurality of through holes 51h formed at intervals in the X direction and the Y direction.

The bus bar modules 500 are provided on an upper face 51a of the insulating plate 51. Each of the bus bar modules 500 includes one or more bus bars 510. Each bus bar module 500 includes a plurality of the bus bars 510 arrayed in the Y direction. Note that the number of bus bar rows included in the bus bar module 500 may be one. Also, the number of bus bars 510 included in the bus bar row may be one.

Each of the bus bars 510 is made of a conductive material such as a metal material or the like. The bus bar 510 electrically connects a pair of the power storage cells 100 adjacent to each other in the Y direction.

The power storage stacks 10 are disposed on upper faces of the bus bar modules 500. External terminals of the power storage cell 100 included in each of the power storage stacks 10 are connected to the bus bar module 500, whereby the power storage cells 100 are electrically connected in series.

The insulating protectors 52 are made of a heat-resistant material (for example, mica). The insulating protectors 52 are provided on the upper face 51a of the insulating plate 51. The insulating protectors 52 are provided so as to close the through holes 51h arrayed in the Y direction. The insulating protectors 52 each includes a strip portion 52a extending in the Y direction, and a plurality of blocking portions 52b formed on a lower face of the strip portion 52a. Each of the blocking portions 52b is disposed inside a through hole 51h.

The cooling device 70 includes a plurality of cooling plates 71, an equipment cooler 72, an upstream pipe 73, and a downstream pipe 74. Note that the cooling plate 71 is an example of "cooling pipe" of the present disclosure.

Each of the cooling plates 71 is disposed between a pair of the power storage stacks 10 adjacent to each other in the X direction. Each cooling plate 71 is formed in a plate form that is long in the Y direction. Each cooling plate 71 has a channel through which coolant flows along the Y direction. In the first embodiment, the number of the cooling plates 71 is five, but the number of the cooling plates 71 is not limited to five. The number of the cooling plates 71 is determined in accordance with the number of the power storage stacks 10.

The equipment cooler 72 cools the equipment 60. The equipment cooler 72 is provided between the bottom plate 211 and the equipment 60.

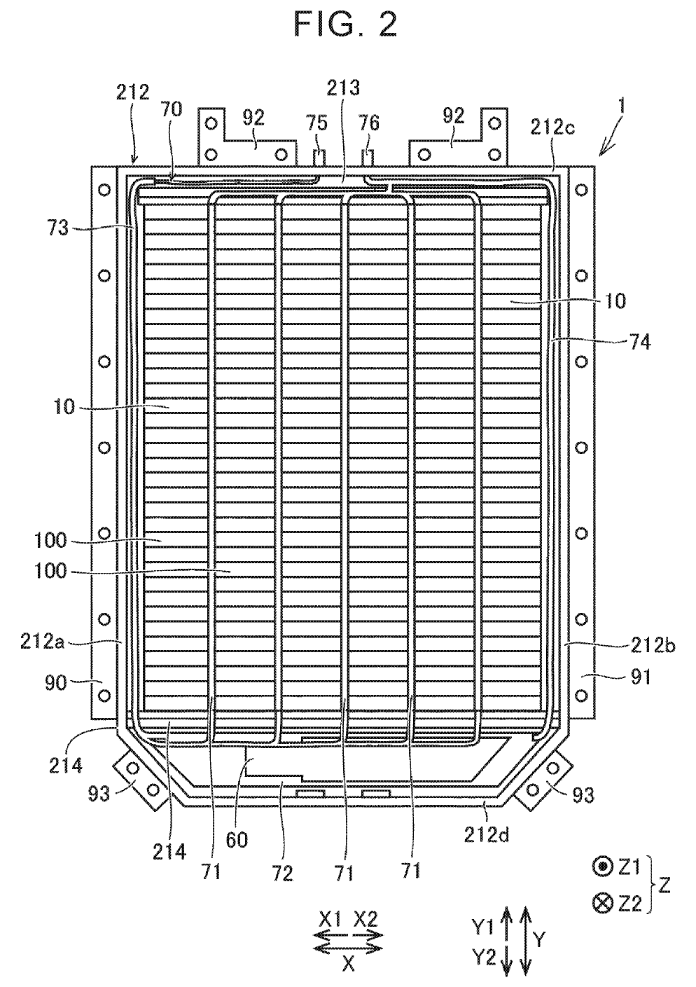

FIG. 2 is a plan view schematically illustrating the power storage device illustrated in FIG. 1, in a state in which the upper cover 220 is removed therefrom.

Each of the upstream pipe 73 and the downstream pipe 74 is a pipe through which a coolant (water, oil, or the like) passes. An inlet port 75 and an outlet port 76 are provided on the end plate 212c of the peripheral wall 212.

The upstream side end portion of the upstream pipe 73 is connected to the inlet port 75. The upstream pipe 73 has six downstream side end portions. One downstream side end portion of the upstream pipe 73 is connected to the equipment cooler 72. The remaining downstream side end portions of the upstream pipe 73 are each connected to the cooling plate 71.

The downstream pipe 74 has six upstream side end portions. One upstream side end portion of the downstream pipe 74 is connected to the equipment cooler 72. The remaining upstream side end portions of the downstream pipe 74 are each connected to the cooling plate 71. A downstream side end portion of the downstream pipe 74 is connected to the outlet port 76. The coolant supplied from the inlet port 75 flows into each of the cooling plates 71 and the equipment cooler 72 through the upstream pipe 73, cools each of the power storage cells 100 and the equipment 60, and then flows out from the outlet port 76 through the downstream pipe 74.

The cooling plates 71 are disposed between pairs of power storage cells 100 adjacent in the X direction. Each cooling plate 71 is formed in a plate form that is long in the Y direction.

The side wall 212a, the side wall 212b, the end plate 212c, and the end plate 212d are provided with a fixing portion 90, a fixing portion 91, a fixing portion 92, and a fixing portion 93, respectively. Each of the fixed portions 90 to 93 is fixed to a body of the vehicle (omitted from illustration).

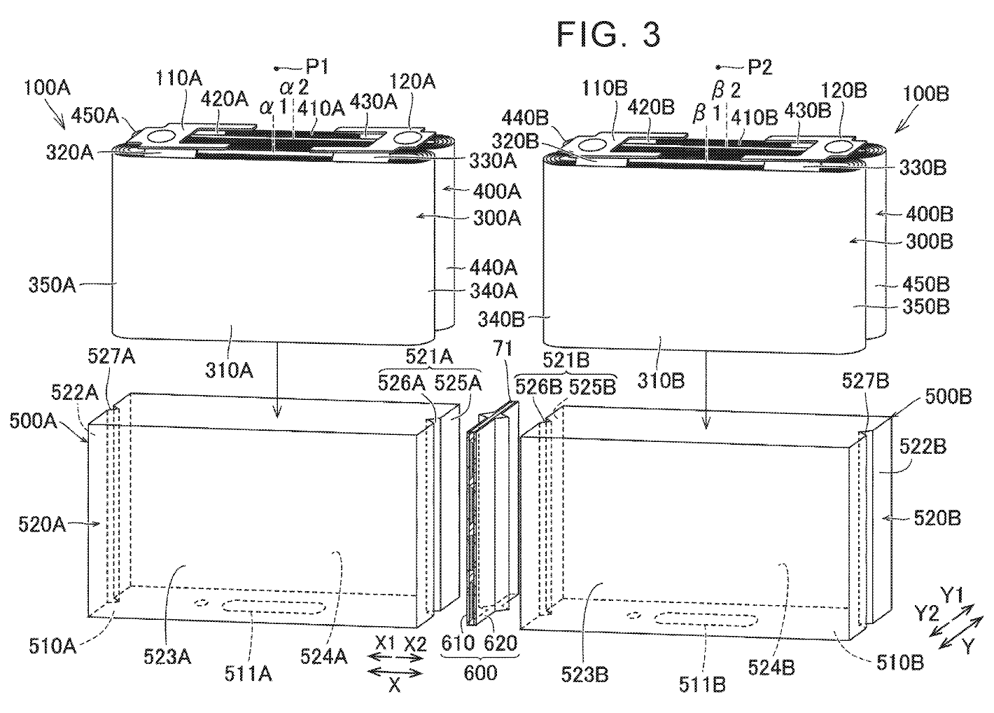

FIG. 3 is a perspective view illustrating the power storage cells 100 adjacent to each other in the X direction. Note that in the following description, out of the power storage cells 100, the power storage cell 100 on the X1 side will be referred to as a power storage cell 100A, and the power storage cell 100 on the X2 side will be referred to as a power storage cell 100B. Note that the power storage cell 100A and the power storage cell 100B have the same configuration.

The power storage cell 100A includes a wound electrode assembly 300A, a wound electrode assembly 400A, a cell case 500A, a cathode current collector plate 110A, and an anode current collector plate 120A. The power storage cell 100B includes a wound electrode assembly 300B, a wound electrode assembly 400B, a cell case 500B, a cathode current collector plate 110B, and an anode current collector plate 120B. The power storage cell 100A and the power storage cell 100B are examples of "first power storage cell" and "second power storage cell" according to the present disclosure, respectively. Also, the wound electrode assembly 300A is an example of "first wound electrode assembly" and "second electrode assembly" according to the present disclosure. The wound electrode assembly 400A is an example of "first wound electrode assembly" and "first electrode assembly" according to the present disclosure. The wound electrode assembly 300B is an example of "second wound electrode assembly" and "fourth electrode assembly" according to the present disclosure. The wound electrode assembly 400B is an example of "second wound electrode assembly" and "third electrode assembly" according to the present disclosure. Also, the cell case 500A and the cell case 500B are examples of "first housing case" and "second housing case" according to the present disclosure, respectively.

The power storage cell 100A and the power storage cell 100B have the same configuration. The wound electrode assembly 300B, the wound electrode assembly 400B, the cell case 500B, the cathode current collector plate 110B, and the anode current collector plate 120B correspond to the wound electrode assembly 300A, the wound electrode assembly 400A, the cell case 500A, the cathode current collector plate 110A, and the anode current collector plate 120A, respectively. In the following, description of configurations of the power storage cell 100B that are the same those of the power storage cell 100A may be omitted or simplified.

The wound electrode assembly 300A and the wound electrode assembly 400A are disposed side by side in the Y direction. The wound electrode assembly 300A and the wound electrode assembly 400A have the same configuration.

The wound electrode assembly 300A is wound so as to surround a periphery of a winding axis α1 extending in the Z direction. The wound electrode assembly 400A is wound so as to surround a periphery of a winding axis α2 extending in the Z direction. The position of the winding axis α1 in the X direction is the same as the position of the winding axis α2 in the X direction. Note that each of the winding axis α1 and the winding axis α2 is an example of "first winding axis" according to the present disclosure.

Similar to the wound electrode assembly 300A and the wound electrode assembly 400A, the wound electrode assembly 300B is wound so as to surround a periphery of a winding axis β1 extending in the Z direction, and the wound electrode assembly 400B is wound so as to surround a periphery of a winding axis β2 extending in the Z direction. Note that each of the winding axis β1 and the winding axis β2 is an example of "second winding axis" according to the present disclosure.

The wound electrode assembly 300A includes a wound portion 310A, a cathode tab 320A, and an anode tab 330A.

The wound portion 310A is made up of an electrode plate group in which a cathode sheet (omitted from illustration) and an anode sheet (omitted from illustration) are wound with one or more separators (omitted from illustration) interposed therebetween.

The cathode tab 320A protrudes from the wound portion 310A toward the Z1 side. The cathode tab 320A electrically connects the wound portion 310A (cathode sheet) and the cathode current collector plate 110A. Note that the cathode current collector plate 110A is electrically connected to an external cathode terminal (omitted from illustration) of the power storage cell 100A.

The anode tab 330A protrudes from the wound portion 310A toward the Z1 side. The anode tab 330A electrically connects the wound portion 310A (anode sheet) and the anode current collector plate 120A. Note that the anode current collector plate 120A is electrically connected to an external anode terminal (omitted from illustration) of the power storage cell 100A.

The wound electrode assembly 400A includes a wound portion 410A, a cathode tab 420A, and an anode tab 430A. The wound portion 410A, the cathode tab 420A, and the anode tab 430A have the same configurations as the wound portion 310A, the cathode tab 320A, and the anode tab 330A, respectively.

The wound electrode assembly 300B includes a wound portion 310B, a cathode tab 320B, and an anode tab 330B. The wound electrode assembly 400B includes a wound portion 410B, a cathode tab 420B, and an anode tab 430B.

The cell case 500A houses the wound electrode assembly 300A and the wound electrode assembly 400A. The cell case 500A includes a bottom face 510A and a peripheral wall 520A. The wound electrode assembly 300A and the wound electrode assembly 400A are surrounded by the peripheral wall 520A when viewed from a position P1 away from the cell case 500A on the Z1 side.

The peripheral wall 520A has a side face 521A, a side face 522A, a side face 523A, and a side face 524A. Note that the side face 521A is an example of "first side face" in the present disclosure.

The side face 521A is provided at an end portion of the cell case 500A on the X2 side (cell case 500B side). The side face 522A is provided at an end portion of the cell case 500A on the X1 side. The side face 523A is provided at an end portion of the cell case 500A on the Y2 side. The side face 524A is provided at an end portion of the cell case 500A on the Y1 side.

An exhaust valve 511A is provided on the bottom face 510A. The exhaust valve 511A is a pressure relief valve that discharges gas to the outside of the cell case 500A when internal pressure of gas in the cell case 500A reaches or exceeds a certain level.

The cell case 500B houses the wound electrode assembly 300B and the wound electrode assembly 400B. The cell case 500B includes a bottom face 510B and a peripheral wall 520B. The wound electrode assembly 300B and the wound electrode assembly 400B are surrounded by the peripheral wall 520B when viewed from a position P2 away from the cell case 500B on the Z1 side.

The peripheral wall 520B has a side face 521B, a side face 522B, a side face 523B, and a side face 524B. Note that the side face 521B is an example of "second side face" in the present disclosure.

The side face 521B is provided at an end portion of the cell case 500B on the X1 side (cell case 500A side). The side face 522B is provided at an end portion of the cell case 500B on the X2 side. The side face 523B is provided at an end portion of the cell case 500B on the Y2 side. The side face 524B is provided at an end portion of the cell case 500B on the Y1 side.

An exhaust valve 511B is provided on the bottom face 510B. The exhaust valve 511B is a pressure release valve, similar to the exhaust valve 511A.

The power storage device 1 (FIG. 2) further includes an adhesive material 600. The adhesive material 600 is disposed between the cell case 500A and the cell case 500B. The adhesive material 600 may be made of a resin (e.g., epoxy resin). Note that the material of the adhesive material 600 is not limited to this example.

The cooling plate 71 passes through the adhesive material 600. Thus, the coolant flowing through the cooling plate 71 can effectively cool each of the power storage cell 100A and the power storage cell 100B. Also, the adhesive material 600 can be cooled by the power storage cell 100A and the power storage cell 100B.

The adhesive material 600 includes an adhesive layer 610 and an adhesive layer 620. The adhesive layer 610 is disposed (filled in) between the cell case 500A and the cooling plate 71. The adhesive layer 620 is disposed (filled in) between the cell case 500B and the cooling plate 71.

The side face 521A of the cell case 500A includes a principal surface 525A. Also, a recessed portion 526A that is recessed from the principal surface 525A toward the X1 side is formed in the side face 521A. The recessed portion 526A extends from an end portion of the cell case 500A on the Z1 side to an end portion of the cell case 500A on the Z2 side. Note that the principal surface 525A and the recessed portion 526A are examples of "first principal surface" and "first recessed portion" of the present disclosure, respectively.

A recessed portion 527A having the same shape as the recessed portion 526A is also formed in the side face 522A of the cell case 500A.

The side face 521B of the cell case 500B includes a principal surface 525B. Also, a recessed portion 526B that is recessed from the principal surface 525B toward the X2 side is formed in the side face 521B. The recessed portion 526B extends from an end portion of the cell case 500B on the Z1 side to an end portion of the cell case 500B on the Z2 side. Note that the principal surface 525B and the recessed portion 526B are examples of "second principal surface" and "second recessed portion" of the present disclosure, respectively.

A recessed portion 527B similar to the recessed portion 526B is also formed on the side face 522B of the cell case 500B.

The wound electrode assembly 300A (wound portion 310A) includes an arcuate portion 340A and an arcuate portion 350A. The arcuate portion 340A is provided at an end portion of the wound electrode assembly 300A on the X2 side. The arcuate portion 350A is provided at an end portion of the wound electrode assembly 300A on the X1 side. Each of the arcuate portion 340A and the arcuate portion 350A has an arcuate shape when viewed from the position P1 away from the power storage cell 100A in the Z direction. The arcuate portion 340A is an example of a "first arcuate portion" in the present disclosure.

The wound electrode assembly 400A (wound portion 410A) includes an arcuate portion 440A and an arcuate portion 450A. The arcuate portion 440A is provided at an end portion of the wound electrode assembly 400A on the X2 side. The arcuate portion 450A is provided at an end portion of the wound electrode assembly 400A on the X1 side. Each of the arcuate portion 440A and the arcuate portion 450A has an arcuate shape as viewed from the position P1. Note that the arcuate portion 440A is an example of "first arcuate portion" according to the present disclosure.

The wound electrode assembly 300B (wound portion 310B) includes an arcuate portion 340B and an arcuate portion 350B. The arcuate portion 340B is provided at an end portion of the wound electrode assembly 300B on the X1 side. The arcuate portion 350B is provided at an end portion of the wound electrode assembly 300B on the X2 side. Each of the arcuate portion 340B and the arcuate portion 350B has an arcuate shape when viewed from the position P2 away from the power storage cell 100B in the Z direction. Note that the arcuate portion 340B is an example of "second arcuate portion" according to the present disclosure.

The wound electrode assembly 400B (wound portion 410B) includes an arcuate portion 440B and an arcuate portion 450B. The arcuate portion 440B is provided at an end portion of the wound electrode assembly 400B on the X1 side. The arcuate portion 450B is provided at an end portion of the wound electrode assembly 400B on the X2 side. Each of the arcuate portion 440B and the arcuate portion 450B has an arcuate shape as viewed from the position P2. Note that the arcuate portion 440B is an example of "second arcuate portion" according to the present disclosure.

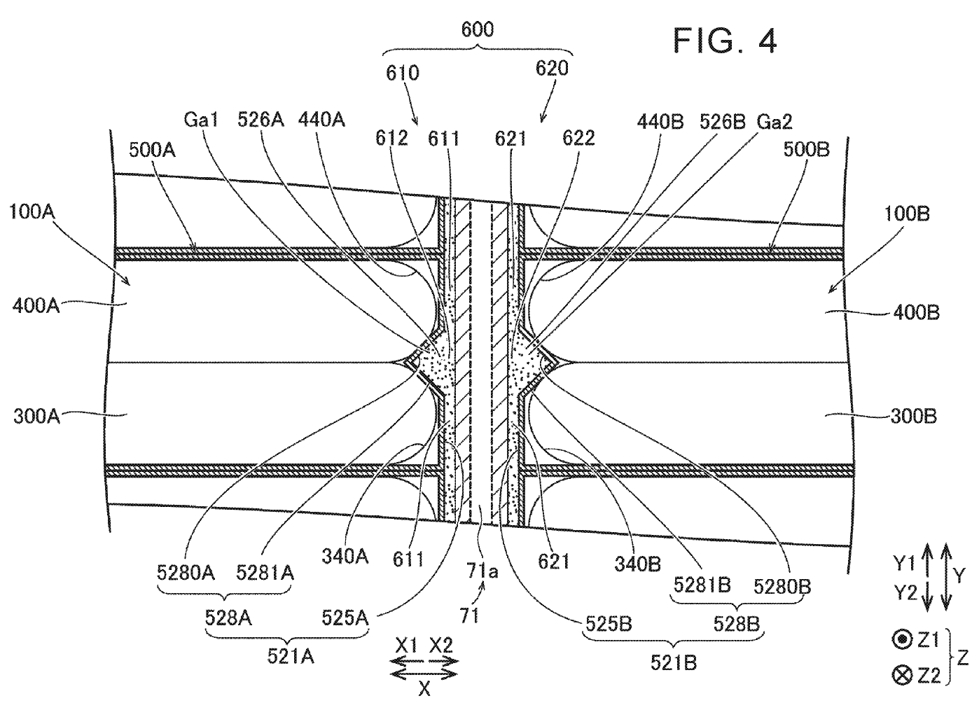

FIG. 4 is a partially enlarged view of a vicinity of the adhesive material 600 in a cross-sectional view of the power storage cell 100A and the power storage cell 100B.

As illustrated in FIG. 4, each of the arcuate portion 340A and the arcuate portion 440A is disposed in a position facing the side face 521A. Each of the arcuate portion 340B and the arcuate portion 440B is disposed in a position facing the side face 521B.

The arcuate portion 340A and the arcuate portion 440A are disposed side by side in the Y direction. A gap Ga1 is formed between the arcuate portion 340A and the arcuate portion 440A. The arcuate portion 340B and the arcuate portion 440B are disposed side by side in the Y direction. A gap Ga2 is formed between the arcuate portion 340B and the arcuate portion 440B. Note that the gap Ga1 and the gap Ga2 are examples of "first gap" and "second gap" according to the present disclosure, respectively.

The recessed portion 526A is formed so as to be recessed from the principal surface 525A of the cell case 500A toward the gap Ga1. The recessed portion 526B is formed so as to be recessed from the principal surface 525B of the cell case 500B toward the gap Ga2.

Now, in a conventional module, when the power storage cells expand (contract) due to charging and discharging, misalignment will conceivably occur among the power storage cells.

In the first embodiment, the adhesive material 600 (adhesive layer 610) fills in the recessed portion 526A. The adhesive material 600 (adhesive layer 620) fills in the recessed portion 526B.

The side face 521A includes a defining face 528A that defines the recessed portion 526A. The side face 521B includes a defining face 528B that defines the recessed portion 526B. The defining face 528B is disposed at a position adjacent to the defining face 528A in the X direction. That is to say, the defining face 528B is disposed at the same position as the defining face 528A in the Y direction. Note that an arrangement may be made in which just a portion of the defining face 528B is disposed within a range in the Y direction in which the defining face 528A is disposed. Furthermore, the defining face 528A and the defining face 528B are examples of "first defining face" and "second defining face" according to the present disclosure, respectively.

The defining face 528A extends from the principal surface 525A into the gap Ga1. The defining face 528B extends from the principal surface 525B into the gap Ga2.

The defining face 528A has an inclined face 5280A and an inclined face 5281A. The inclined face 5280A is disposed on the Y1 side relative to the inclined face 5281A. The inclined face 5280A is inclined so as to be farther away from the power storage cell 100B (X1 side) the closer it is to the inclined face 5281A side (Y2 side). The inclined face 5281A is inclined so as to be farther away from the power storage cell 100B the closer it is to the inclined face 5280A side (Y1 side). X1 side end portions of the inclined face 5280A and the inclined face 5281A are connected to each other. Note that the inclined face 5280A and the inclined face 5281A are examples of "first inclined face" and "second inclined face" according to the present disclosure, respectively.

The defining face 528B has an inclined face 5280B and an inclined face 5281B. The inclined face 5280B is disposed on the Y1 side relative to the inclined face 5281B. The inclined face 5280B is inclined so as to be farther away from the power storage cell 100A (X2 side) the closer it is to the inclined face 5281B side (Y2 side). The inclined face 5281B is inclined so as to be farther away from the power storage cell 100A the closer it is to the inclined face 5280B side (Y1 side). X2 side end portions of the inclined face 5280B and the inclined face 5281B are connected to each other. Note that the inclined face 5280B and the inclined face 5281B are examples of "third inclined face" and "fourth inclined face" according to the present disclosure, respectively.

The inclined face 5280A is in contact with the arcuate portion 440A of the wound electrode assembly 400A. The inclined face 5281A is in contact with the arcuate portion 340A of the wound electrode assembly 300A. The inclined face 5280B is in contact with the arcuate portion 440B of the wound electrode assembly 400B. The inclined face 5281B is in contact with the arcuate portion 340B of the wound electrode assembly 300B. This allows space of each of the recessed portion 526A and the recessed portion 526B to be easily increased, and accordingly the amount of adhesive material 600 filling each of the recessed portion 526A and the recessed portion 526B can be increased.

Note that in the first embodiment, each of the inclined face 5280A, the inclined face 5281A, the inclined face 5280B, and the inclined face 5281B is formed as a flat surface, but the defining faces that define the recessed portions may be curved, for example. Also, each of the recessed portion 526A and the recessed portion 526B has a triangular shape when viewed from the Z1 side, but may instead have a rectangular shape when viewed from the Z1 side, for example.

The adhesive layer 610 includes an adhesive portion 611 and an adhesive portion 612. The adhesive layer 620 includes an adhesive portion 621 and an adhesive portion 622.

Each of the adhesive portion 611 and the adhesive portion 621 is disposed between the principal surface 525A of the cell case 500A and the principal surface 525B of the cell case 500B. Specifically, the adhesive portion 611 is clamped between the principal surface 525A and the cooling plate 71 in the X direction. The adhesive portion 621 is clamped between the principal surface 525B and the cooling plate 71 in the X direction.

Each of the adhesive portion 612 and the adhesive portion 622 is disposed between the defining face 528A of the cell case 500A and the defining face 528B of the cell case 500B. Specifically, the adhesive portion 612 is clamped between the defining face 528A and the cooling plate 71 in the X direction. The adhesive portion 622 is clamped between the defining face 528B and the cooling plate 71 in the X direction.

Thus, the power storage cell 100A can be fixed to the cooling plate 71 more stably as compared to when the adhesive layer 610 includes only the adhesive portion 612. Similarly, the power storage cell 100B can be more stably fixed to the cooling plate 71.

The adhesive portion 611 includes a portion between the wound electrode assembly 300A and the cooling plate 71 (hereinafter referred to as first portion), and a portion between the wound electrode assembly 400A and the cooling plate 71 (hereinafter referred to as second portion). The adhesive portion 612 is disposed between the first portion of the adhesive portion 611 and the second portion of the adhesive portion 611, and is formed integrally with the first portion of the adhesive portion 611 and the second portion of the adhesive portion 611.

The adhesive portion 621 includes a portion between the wound electrode assembly 300B and the cooling plate 71 (hereinafter referred to as first portion), and a portion between the wound electrode assembly 400B and the cooling plate 71 (hereinafter referred to as second portion). The adhesive portion 622 is disposed between the first portion of the adhesive portion 621 and the second portion of the adhesive portion 621, and is formed integrally with the first portion of the adhesive portion 621 and the second portion of the adhesive portion 621.

A channel 71a through which the coolant flows is formed inside the cooling plate 71. The channel 71a extends in the Y direction. It should be noted that a plurality of the channels 71a may be arrayed in the Z direction.

The cooling plate 71 is formed such that the thickness thereof in the X direction is constant. Accordingly, the thickness of the adhesive portion 612 in the X direction is greater than the thickness of the adhesive portion 611 in the X direction. The thickness of the adhesive portion 612 in the X direction gradually increases toward the connection point between the inclined face 5280A and the inclined face 5281A. The same applies to the adhesive portion 621 and the adhesive portion 622.

As described above, in the first embodiment, the adhesive material 600 fills in each of the recessed portion 526A and the recessed portion 526B. This allows the adhesive material 600 that fills in the recessed portion 526A to bond the cell case 500A to the cooling plate 71, and also allows the adhesive material 600 that fills in the recessed portion 526B to bond the cell case 500B to the cooling plate 71. As a result, misalignment between the power storage cell 100A and the power storage cell 100B can be suppressed.

Also, the adhesive material 600 fills in the recessed portion 526A (recessed portion 526B), even when force (frictional force) is applied to the adhesive material 600 in the Y direction, the adhesive material 600 can be suppressed from peeling off from the side face 521A (side face 521B) due to the adhesive material 600 being pulled in the Y direction.

### Second Embodiment

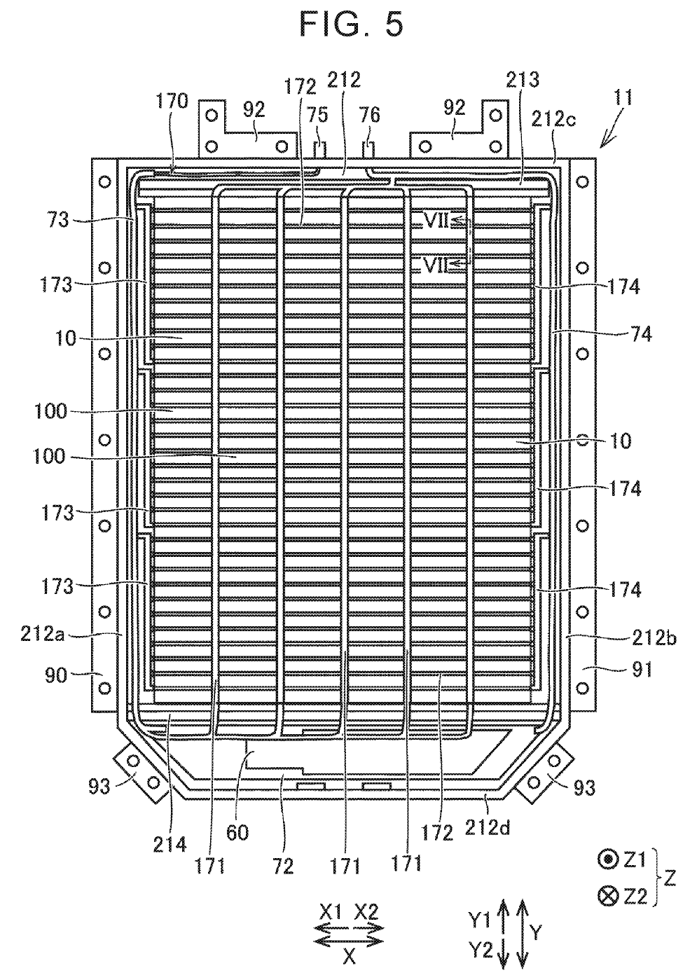

Next, a second embodiment of the present disclosure will be described with reference to FIGS. 5 to 7. A power storage device 11 according to the second embodiment includes a cooling device 170 instead of the cooling device 70 according to the first embodiment. Note that components that are the same as those in the first embodiment are denoted by the same reference numerals as those in the first embodiment, and description thereof will not be repeated.

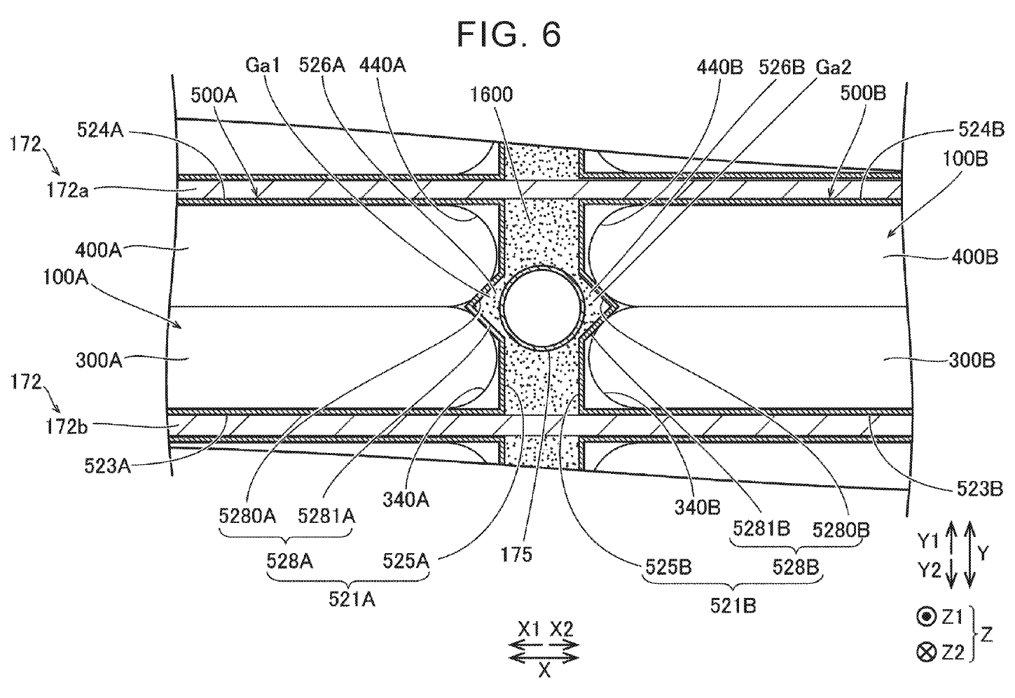

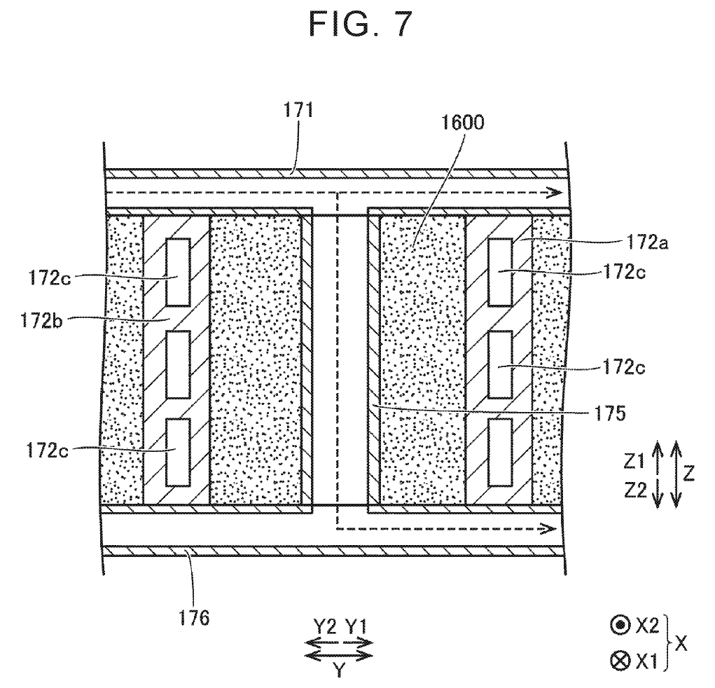

As illustrated in FIG. 5, the power storage device 11 includes the cooling device 170. The cooling device 170 includes a plurality of coolant pipes 171, a plurality of cooling plates 172, a plurality of supply pipes 173, a plurality of discharge pipes 174, a plurality of connecting pipes 175 (FIG. 6), a plurality of coolant pipes 176 (FIG. 7), the equipment cooler 72, the upstream pipe 73, and the downstream pipe 74. Note that the connecting pipes 175 are an example of "cooling pipe" according to the present disclosure.

Each of the cooling plates 172 is disposed between the power storage cells 100 that are adjacent to each other in the Y direction. The cooling plates 172 each extend in the X direction, and connect the supply pipes 173 and the discharge pipes 174.

Each of the supply pipes 173 extends in the Y direction along the upstream pipe 73, and supplies the coolant from the upstream pipe 73 to each of the cooling plates 172. The supply pipes 173 are disposed in a row in the Y direction.

Each of the discharge pipes 174 extends in the Y direction along the downstream pipe 74 and discharges the coolant from each of the cooling plates 172 into the downstream pipe 74. The discharge pipes 174 are disposed in a row in the Y direction.

The coolant flowing through the upstream pipe 73 flows into each of the coolant pipes 171. As viewed from a position away from the power storage device 11 on the Z1 side, each of the coolant pipes 171 is disposed at a position between the power storage cells 100 that are adjacent to each other in the X direction. Each of the coolant pipes 171 extends in the Y direction along the power storage stack 10. The coolant flowing through each of the coolant pipes 171 is discharged from the outlet port 76.

The cooling plate 172 disposed on the Y1 side of the power storage cell 100A and the power storage cell 100B will be referred to as a cooling plate 172a, and the cooling plate 172 disposed on the Y2 side of the power storage cell 100A and the power storage cell 100B will be referred to as a cooling plate 172b in the following description, as illustrated in FIG. 6. The cooling plate 172a and the cooling plate 172b are examples of "first cooler" and "second cooler" according to the present disclosure, respectively.

The cooling plate 172a is disposed spanning the side face 524A of the cell case 500A and the side face 524B of the cell case 500B. The cooling plate 172a may be in contact with the side face 524A and the side face 524B. Note that the side face 524A and the side face 524B are examples of "first case side face" and "third case side face" according to the present disclosure, respectively.

The cooling plate 172b is disposed spanning the side face 523A of the cell case 500A and the side face 523B of the cell case 500B. The cooling plate 172b may be in contact with the side face 523A and the side face 523B. Note that side face 523A and the side face 523B are examples of "second case side face" and "fourth case side face" according to the present disclosure, respectively.

The power storage device 11 (FIG. 5) further includes an adhesive material 1600. The adhesive material 1600 is disposed (filled) in the space between the power storage cell 100A and the power storage cell 100B that are disposed side by side in the X direction.

In the second embodiment, the adhesive material 1600 extends in the Y direction and is also connected to each of the cooling plate 172a and the cooling plate 172b. That is to say, the adhesive material 1600 is bonded to each of the cooling plate 172a and the cooling plate 172b.

Thus, the cooling plate 172a and the cooling plate 172b are connected by the adhesive material 1600, and accordingly misalignment between the cooling plate 172a and the cooling plate 172b can be suppressed.

The connecting pipes 175 pass through the adhesive material 1600. Each of the connecting pipes 175 has an annular shape in the cross-section illustrated in FIG. 6. The connecting pipe 175 is disposed between the defining face 528A that defines the recessed portion 526A and the defining face 528B that defines the recessed portion 526B. A portion of the connecting pipe 175 may extend into each of the recessed portion 526A and the recessed portion 526B.

The connecting pipe 175 extends in the Z direction within the adhesive material 1600. Thus, the coolant flowing through the connecting pipe 175 passes through the space between the power storage cell 100A and the power storage cell 100B, such that the coolant flowing through the connecting pipe 175 can effectively cool the storage cell 100A and the storage cell 100B. Also, the connecting pipe 175 extends in the Z direction, and accordingly the connecting pipe 175 can be suppressed from interfering with the cooling plate 172.

FIG. 7 is a cross-sectional view taken along line VII-VII in FIG. 5. The connecting pipe 175 passes through the adhesive material 1600 in the Z direction. Each of the connecting pipes 175 communicate with each of the coolant pipe 171 and the coolant pipe 176. Note that the coolant pipes 176 extends in the Y direction downward (Z2 side) from each of the coolant pipes 171. The connecting pipes 175 may be formed integrally with each of the coolant pipes 171 and the coolant pipes 176.

A portion of the coolant flowing through the coolant pipes 171 passes through the connecting pipes 175 and then flows into the coolant pipes 176. The coolant that flows into the coolant pipes 176 flows to the Y1 side, and is then discharged from the outlet port 76 (FIG. 5) connected to the coolant pipes 176. Note that the dashed lines in FIG. 7 indicate the flow of the coolant.

Each of the cooling plate 172a and the cooling plate 172b has a plurality of channels 172c formed therein. The channels 172c are arrayed in the Z direction in each of the cooling plate 172a and the cooling plate 172b.

Note that other configurations are the same as those of the first embodiment, and accordingly will not be repeated.

### Modifications

In the above first and second embodiments, examples have been described in which the adhesive material is disposed between the principal surface 525A and the principal surface 525B, and between the defining face 528A and the defining face 528B, but the present disclosure is not limited to this. The adhesive material may be disposed just between the defining face 528A and the defining face 528B.

In the above-described first and second embodiments, an example has been described in which the cooling pipes (71, 175), through which the coolant flows, pass through the adhesive material, but the present disclosure is not limited to this. The cooling pipes do not have to pass through the adhesive material.

The configurations of the above embodiments and modifications may be combined with each other.

Note that the embodiment disclosed herein should be considered to be exemplary in all respects and not restrictive. The scope of the present disclosure is set forth in the claims, and not the description of the embodiment described above, and further all changes within the meaning and scope equivalent to the claims are included therein.

What is claimed is:

1. A power storage device comprising:
a first power storage cell including a plurality of first wound electrode assemblies disposed side by side in a first direction, and a first housing case that houses the first wound electrode assemblies;
a second power storage cell including a plurality of second wound electrode assemblies disposed side by side in the first direction, and a second housing case that houses the second wound electrode assemblies; and
an adhesive material disposed between the first housing case and the second housing case, wherein:
each of the first wound electrode assemblies is wound so as to surround a periphery of a first winding axis that extends in an axial direction intersecting the first direction;
each of the second wound electrode assemblies is wound so as to surround a periphery of a second winding axis that extends in the axial direction;
the second power storage cell is disposed at a position adjacent to the first power storage cell in a second direction intersecting each of the first direction and the axial direction;
the first housing case includes a first side face disposed on the second housing case side in the second direction;
the second housing case includes a second side face disposed on the first housing case side in the second direction;
each of the first wound electrode assemblies is disposed at a position facing the first side face, and includes a first arcuate portion with an arcuate shape as viewed from a position away from the first power storage cell in the axial direction;
each of the second wound electrode assemblies is disposed at a position facing the second side face, and includes a second arcuate portion with an arcuate shape as viewed from a position away from the second power storage cell in the axial direction;
the first side face includes a first principal surface, and also, a first recessed portion that is recessed from the first principal surface toward a first gap between the first arcuate portions aligned in the first direction is created in the first side face;
the second side face includes a second principal surface, and also, a second recessed portion that is recessed from the second principal surface toward a second gap between the second arcuate portions aligned in the first direction is created in the second side face; and
the adhesive material fills in each of the first recessed portion and the second recessed portion.

2. The power storage device according to claim 1, further comprising a cooling pipe that passes through the adhesive material.

3. The power storage device according to claim 1, further comprising a first cooler and a second cooler extending in the second direction, wherein:
the first housing case includes
a first case side face on one side in the first direction, and
a second case side face on another side in the first direction;
the second housing case includes
a third case side face on the one side in the first direction, and
a fourth case side face on the other side in the first direction;
the first cooler is disposed spanning the first case side face and the third case side face;
the second cooler is disposed spanning the second case side face and the fourth case side face; and
the adhesive material extends in the first direction and also is connected to each of the first cooler and the second cooler.

4. The power storage device according to claim 3, further comprising a cooling pipe that passes through the adhesive material, wherein the cooling pipe extends in the axial direction within the adhesive material.

5. The power storage device according to claim 1, wherein:
the first side face includes a first defining face that defines the first recessed portion;
the second side face includes a second defining face that defines the second recessed portion;
the first defining face includes a first inclined face, and a second inclined face that is connected to the first inclined face and that is also disposed on one side of the first inclined face in the first direction;
the second defining face includes a third inclined face, and a fourth inclined face that is connected to the third inclined face and that is also disposed on the one side of the third inclined face in the first direction;
the first inclined face is inclined in a direction so as to be farther away from the second power storage cell, closer to the second inclined face;
the second inclined face is inclined in a direction so as to be farther away from the second power storage cell, closer to the first inclined face;
the third inclined face is inclined in a direction so as to be farther away from the first power storage cell, closer to the fourth inclined face;
the fourth inclined face is inclined in a direction so as to be farther away from the first power storage cell, closer to the third inclined face;
the first wound electrode assemblies include a first electrode assembly, and a second electrode assembly that is disposed on the one side in the first direction with respect to the first electrode assembly;
the second wound electrode assemblies include a third electrode assembly, and a fourth electrode assembly that is disposed on the one side in the first direction with respect to the third electrode assembly;
the first inclined face is in contact with the first arcuate portion of the first electrode assembly;
the second inclined face is in contact with the first arcuate portion of the second electrode assembly;
the third inclined face is in contact with the second arcuate portion of the third electrode assembly; and
the fourth inclined face is in contact with the second arcuate portion of the fourth electrode assembly.
